(19) United States
(12) Patent Application Publication
(10) Pub. No.: US 2012/0257056 A1
(43) Pub. Date: Oct. 11, 2012

(54) IMAGE PROCESSING APPARATUS, IMAGE PROCESSING METHOD, AND IMAGE PROCESSING PROGRAM

(75) Inventor: Kazuyoshi Otuka, Yokohama-shi (JP)

(73) Assignee: HONDA ELESYS CO., LTD., Yokohama-shi (JP)

(21) Appl. No.: 13/410,038

(22) Filed: Mar. 1, 2012

(30) Foreign Application Priority Data
Mar. 3, 2011 (JP) 2011-046423

(51) Int. Cl. H04N 7/18

(52) U.S. Cl. 348/148; 348/E07.085

(57) ABSTRACT

An image processing apparatus includes image acquisition units which are mounted in a vehicle, and each of which is configured to acquire an image, a vehicle information acquisition unit configured to acquire vehicle information indicating a movement state of the vehicle, and an image correction amount calculation unit configured to calculate an amount of image correction based on positional relationship between a first image acquired by one of the image acquisition units and a second image acquired by the other image acquisition units, wherein the positional relationship is estimated based on the vehicle information.

### CROSS-REFERENCE TO RELATED APPLICATIONS

Priority is claimed on Japanese Patent Application No. 2011-46423, filed Mar. 3, 2011, the contents of which are entirely incorporated herein by reference.

### BACKGROUND OF THE INVENTION

1. Field of the Invention

The present invention relates to an image processing apparatus, an image processing method, and an image processing program.

2. Background Art

In order to ensure safety during travel of a vehicle, technology for recognizing the lane boundaries drawn on the road or obstacles based on an image captured by a camera mounted in the vehicle or technology for combining captured images to call attention to the driver is known.

For example, JP-A-2006-260358 (Patent Document 1) discloses a lane recognition device that extracts a dot-sequence-shaped lane, which draws a linear trajectory over time, based on a feature image extracted from the time-series input image captured through a visual sensor.

### SUMMARY OF THE INVENTION

In the lane recognition device disclosed in Patent Document 1, however, in order to mount a plurality of cameras in a vehicle and display images captured by the cameras, it is necessary to prepare all functions including recognition and display for each camera. Accordingly, there is a problem in that a plurality of images cannot be processed efficiently.

The present invention has been made in view of the above points, and it is an object of the present invention to provide an image processing apparatus, an image processing method, and an image processing program for processing a plurality of images efficiently.

The present invention has been made in order to solve the above-described problem, and a first aspect of the present invention is an image processing apparatus including: image acquisition units which are mounted in a vehicle, and each of which is configured to acquire an image; a vehicle information acquisition unit configured to acquire vehicle information indicating a movement state of the vehicle; and an image correction amount calculation unit configured to calculate an amount of image correction based on positional relationship between a first image acquired by one of the image acquisition units and a second image acquired by the other image acquisition units, wherein the positional relationship is estimated based on the vehicle information.

The image processing apparatus described above may further include a feature point extraction unit configured to extract feature points from the images, and the image correction amount calculation unit may be configured to calculate, as the positional relationship, positional relationship between feature points of the first image and feature points of the second image.

In the image processing apparatus described above, the image correction amount calculation unit may be configured to search for feature points of the second image within a range set in advance based on feature points of the first image.

A second aspect of the present invention is an image processing method including: a step of acquiring images by image acquisition units mounted in a vehicle; a step of acquiring vehicle information indicating a movement state of the vehicle; a step of estimating positional relationship between a first image acquired by one of the image acquisition units and a second image acquired by the other image acquisition units based on the vehicle information; and a step of calculating an amount of image correction based on the positional relationship.

A third aspect of the present invention is an image processing program causing a computer of an image processing apparatus includingimage acquisition units which are mounted in a vehicle, and each of which is configured to acquire an image; and a vehicle information acquisition unit configured to acquire vehicle information indicating a movement state of the vehicle, to execute: a step of acquiring images by the image acquisition units; a step of acquiring vehicle information indicating a movement state of the vehicle; a step of estimating positional relationship between a first image acquired by one of the image acquisition units and a second image acquired by the other image acquisition units based on the vehicle information; and a step of calculating an amount of image correction based on the positional relationship.

According to the present invention, because the amount of image correction is calculated based on the vehicle information and the positional relationship between images, a plurality of images that can be corrected based on the calculated amount of image correction are managed collectively, and it becomes easy to construct a system that uses these images.

### BRIEF DESCRIPTION OF THE DRAWINGS

FIG. 1 is a conceptual diagram showing an image processing system related to an embodiment of the present invention.

FIG. 2 is a plan view showing examples of the field of view of an image captured by a camera and a direction of an optical axis in the present embodiment.

FIG. 3 is a schematic diagram showing the configuration of an image processing apparatus related to the present embodiment.

FIG. 4 is a schematic diagram showing the configuration of an image processing unit related to the present embodiment.

FIG. 5 shows examples of the camera coordinate system and the image coordinate system related to the present embodiment.

FIG. 6 shows examples of the world coordinate system and the camera coordinate system related to the present embodiment.

FIG. 7 is a flowchart showing the processing of extracting the feature points from an image signal in the present embodiment.

FIG. 8 is a conceptual diagram showing examples of a master image and a field-of-view-overlap slave image related to the present embodiment.

FIG. 9 is a conceptual diagram showing an example of the feature point related to the present embodiment.

FIG. 10 is a conceptual diagram showing examples of a master image and a field-of-view-separated slave image related to the present embodiment.

FIG. 11 is a conceptual diagram showing an example of an image predicted from the master image related to the present embodiment.

FIG. 12 is a flowchart showing the image processing related to the present embodiment.

FIG. 13 is a flowchart showing the feature point pair search between field-of-view-overlap cameras related to the present embodiment.

FIG. 14 is a flowchart showing the feature point pair search between field-of-view-separated cameras related to the present embodiment.

### DETAILED DESCRIPTION OF THE INVENTION

### First Embodiment

Hereinafter, embodiments of the present invention will be described in detail with reference to the drawings.

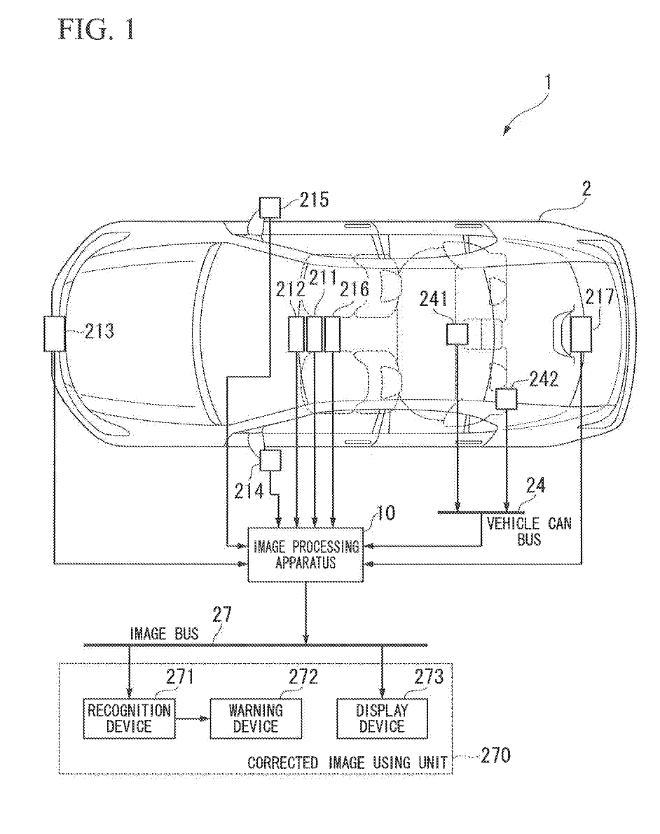

FIG. 1 is a conceptual diagram showing an image processing system 1 related to the embodiment of the present invention.

The image processing system 1 is configured to include an image processing apparatus 10, a plurality of cameras (image acquisition units) 211 to 217, a vehicle CAN (Controller Area Network) bus (vehicle information transmission medium) 24, a plurality of vehicle information sensors (detection units) 241 and 242, an image bus 27 (image information transmission medium), and a corrected image using unit 270. As an example, the corrected image using unit 270 is configured to include a recognition device 271, a warning device 272, and a display device 273.

The cameras 211 to 217 are fixed to different positions of a vehicle 2 and capture images of different fields of view. For example, the front monitoring camera 211 is fixed to the boundary of the top plate on the middle of the windshield of the vehicle 2, and captures an image in front of the vehicle 2 (especially in a narrow range of a distant place). The wide-angle front monitoring camera 212 is also fixed to the boundary of the top plate on the middle of the windshield of the vehicle 2, and captures an image in front of the vehicle 2 (especially in a wide range of a distant place). The left-and-right front dead angle monitoring camera 213 is fixed onto the middle of the tip of the vehicle 2, and captures images on its left and right sides. The left rear dead angle monitoring camera 214 is fixed to the distal end of a left side mirror of the vehicle 2, and captures a left rear image of the vehicle 2. The right rear dead angle monitoring camera 215 is fixed to the distal end of a right side mirror of the vehicle 2, and captures a right rear image of the vehicle 2. The vehicle inside monitoring camera 216 is fixed to the ceiling of the middle of the front row of seats of the vehicle 2, and captures an image of a rear portion of the inside of the vehicle. The rear monitoring camera 217 is fixed to the boundary of the rear plate below the middle of the rear window of the vehicle 2, and captures an image behind the vehicle 2.

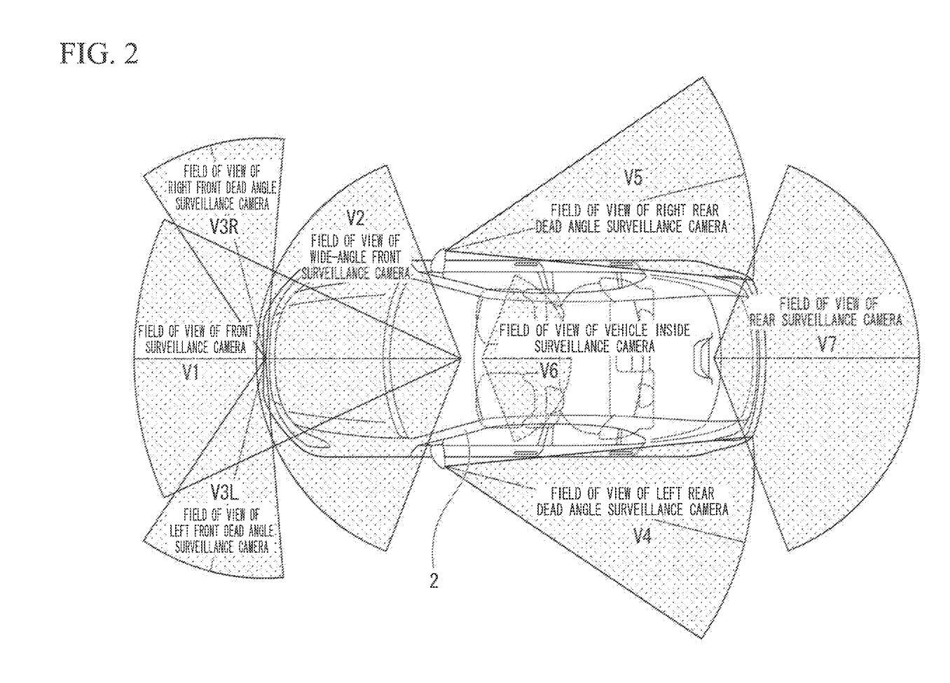

FIG. 2 is a plan view showing examples of the field of view of an image captured by a camera and a direction of the optical axis in the present embodiment. In FIG. 2, a fan-shaped arc portion shown by the solid line is a field of view of an image captured by each camera. The one-dotted chain line shown in the middle of the fan shape shows an optical axis of each camera.

A field of view of a front monitoring camera V1 indicates a field of view of an image captured by the front monitoring camera 211. A field of view of a wide-angle front monitoring camera V2 indicates a field of view of an image captured by the wide-angle front monitoring camera 212. A field of view of a left front dead angle monitoring camera V3L and a field of view of a right front dead angle monitoring camera V3R indicate left and right sides of the field of view of an image captured by the left-and-right front dead angle monitoring camera 213, respectively. A field of view of a left rear dead angle monitoring camera V4 indicates a field of view of an image captured by the left rear dead angle monitoring camera 214. A field of view of a right rear dead angle monitoring camera V5 indicates a field of view of an image captured by the right rear dead angle monitoring camera 215. A field of view of a vehicle inside monitoring camera V6 indicates a field of view of an image captured by the vehicle inside monitoring camera 216. A field of view of a rear monitoring camera V7 indicates a field of view of an image monitored by the rear monitoring camera 217.

FIG. 2 shows that part of the field of view of a front monitoring camera V1 and part of the field of view of a wide-angle front monitoring camera V2 overlap each other, part of the field of view of a left rear dead angle monitoring camera V4 and part of the field of view of a rear monitoring camera V7 overlap each other, and part of the field of view of a right rear dead angle monitoring camera V5 and part of the field of view of a rear monitoring camera V7 overlap each other. However, the fields of view of captured images do not overlap each other for combinations between the other cameras.

Returning to FIG. 1, each of the cameras 211 to 217 outputs an image signal showing the captured image to the image processing apparatus 10.

The yaw rate sensor 241 is fixed to the engine compartment of the vehicle 2, and detects the rotation speed (yaw rate) around the vertical axis of the vehicle 2. The yaw rate sensor 241 outputs the yaw rate information indicating the detected yaw rate to the vehicle CAN bus 24.

The velocity sensor 242 is provided in a housing which holds a hub bearing of the wheel of the vehicle 2, and detects the speed. The yaw rate sensor 242 outputs the speed information indicating the detected speed to the vehicle CAN bus 24.

The vehicle CAN bus 24 receives vehicle information indicating the movement state of the vehicle 2 from each sensor and outputs the input vehicle information to the image processing apparatus 10. Yaw rate information and speed information described above are included in the vehicle information.

In addition, functional units that detect vehicle information including the yaw rate sensor 241 and the velocity sensor 242 are collectively called a vehicle information detection unit.

The image processing apparatus 10 calculates the amount of image correction based on the image signal input from each of the cameras 211 to 217 and the vehicle information input from the vehicle CAN bus 24. The image processing apparatus 10 generates a compressed image signal by performing compression encoding of the input image signal and records the generated compressed image signal and the calculated amount of image correction. In addition, the image processing apparatus 10 outputs the generated compressed image signal and the calculated amount of image correction to the image bus 27.

In addition, the configuration and processing of the image processing apparatus 10 will be described later.

The image bus 27 outputs the compressed image signal and the amount of image correction, which have been input from the image processing apparatus 10, to the recognition device 271 and the display device 273 of the corrected image using unit 270.

The recognition device 271 generates an image signal by decoding the compressed image signal input from the image bus 27. The recognition device 271 generates a corrected image signal by correcting the generated image signal based on the input amount of image correction. The recognition device 271 calculates an index value indicating a correlation between the generated corrected image signal and an image signal of an image showing an obstacle, and generates an obstacle recognition signal when the calculated index value exceeds a threshold value set in advance. This obstacle recognition signal is a signal indicating that the obstacle is in the field of view of a camera which has captured it. The recognition device 271 outputs the generated obstacle recognition signal to the warning device 272.

The warning device 272 receives an obstacle recognition signal from the recognition device 271 and presents warning information (for example, warning sound or a warning screen) indicating that there is an obstacle.

The display device 273 generates an image signal by decoding the compressed image signal input from the image bus 27. The recognition device 271 generates a corrected image signal by correcting the generated image signal based on the input amount of image correction. The display device 273 displays an image based on the generated corrected image signal.

Next, the configuration and processing of the image processing apparatus 10 related to the present embodiment will be described.

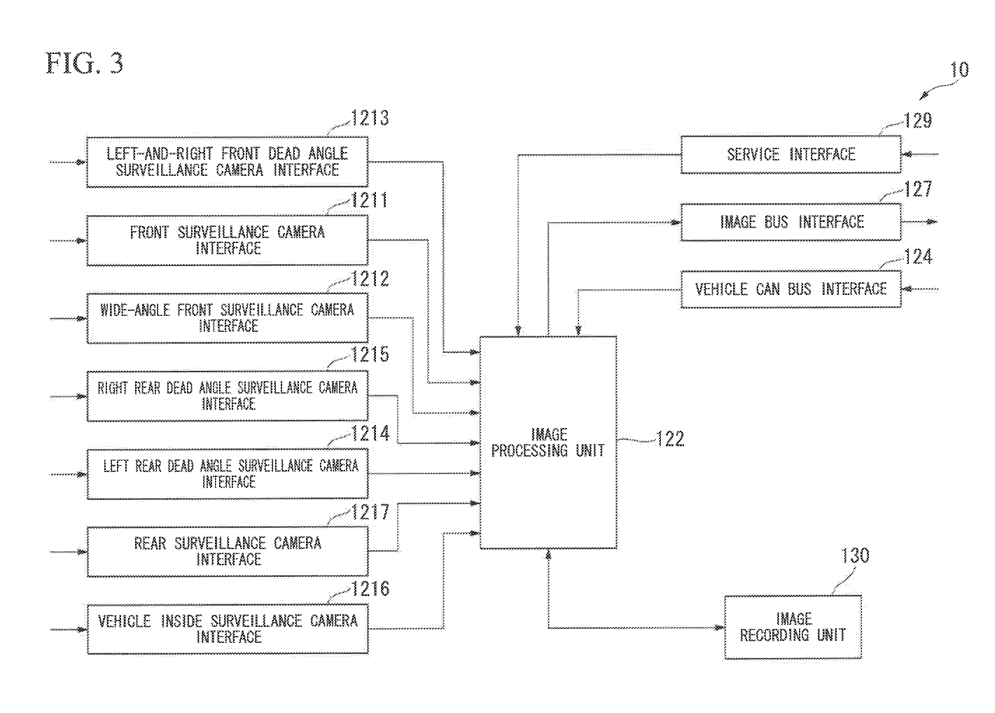

FIG. 3 is a schematic diagram showing the configuration of the image processing apparatus 10 related to the present embodiment.

The image processing apparatus 10 is configured to include camera interfaces (image acquisition units) 1211 to 1217, an image processing unit 122, a vehicle CAN bus interface (vehicle information acquisition unit) 124, an image bus interface 127, a service interface 129, and an image recording unit 130.

The camera interfaces 1211 to 1217 connect conducting wires, through which image signals input from the cameras 211 to 217 are transmitted, to the image processing apparatus 10.

For example, an image signal from the front monitoring camera 211 is input to the front monitoring camera interface 1211. An image signal from the wide-angle front monitoring camera 212 is input to the wide-angle front monitoring camera interface 1212. An image signal from the left-and-right front dead angle monitoring camera 213 is input to the left-and-right front dead angle monitoring camera interface 1213. An image signal from the left rear dead angle monitoring camera 214 is input to the left rear dead angle monitoring camera interface 1214. An image signal from the right rear dead angle monitoring camera 215 is input to the right rear dead angle monitoring camera interface 1215.

An image signal from the vehicle inside monitoring camera 216 is input to the vehicle inside monitoring camera interface 1216. An image signal from the rear monitoring camera 217 is input to the rear monitoring camera interface 1217.

The camera interfaces 1211 to 1217 output to the image processing unit 122 the image signals input from the cameras 211 to 217.

The image processing unit 122 calculates the amount of image correction for each image signal based on the image signal input from each of the camera interfaces 1211 to 1217 and the vehicle information input from the vehicle CAN bus interface 124. The image processing unit 122 generates a compressed image signal with a less amount of information by performing compression encoding of the input image signal, and outputs the generated compressed image signal and the calculated amount of image correction to the image bus interface 127 and the image recording unit 130 in synchronization with each other. Since the image processing unit 122 outputs a compressed image signal as described above, excess and convergence of the capacity or transmission delay at the output destination is avoided.

In addition, the image processing unit 122 outputs to the image recording unit 130 the event information input from the service interface 129.

In addition, the configuration and processing of the image processing unit 122 will be described later.

The vehicle CAN bus interface 124 connects a conducting wire, through which the vehicle information input from the vehicle CAN bus 24 is transmitted, to the image processing apparatus 10 and outputs the vehicle information to the image processing unit 122.

The image bus interface 127 connects a conducting wire, through which the compressed image signal and the amount of image correction are output to the image bus 27, to the image processing apparatus 10 and outputs the compressed image signal and the amount of image correction from the image processing unit 122 to the image bus 27.

The service interface 129 connects a conducting wire, through which the event information from an event information detection unit (not shown) is input, to the image processing apparatus 10 and outputs the event information to the image processing unit 122.

Here, the event information is information indicating the state of the vehicle 2 or the situation around the vehicle 2. For example, the event information is any one or a combination of a handle steering angle, a shift lever position, and the current location of the vehicle 2. Functional units that detect the event information are collectively called an event information detection unit, and the event information detection unit outputs the detected event information to the service interface 129.

The image recording unit 130 stores the compressed image signal, the amount of image correction, and the event information, which are input from the image processing unit 122, so as to match each other each time. Thus, the image recording unit 130 functions as a so-called drive recorder. In addition, when an image request signal is input from the image processing unit 122, the amount of image correction corresponding to the compressed image signal indicated by the image request signal is output to the image processing unit 122.

Next, the configuration and processing of the image processing unit 122 related to the present embodiment will be described.

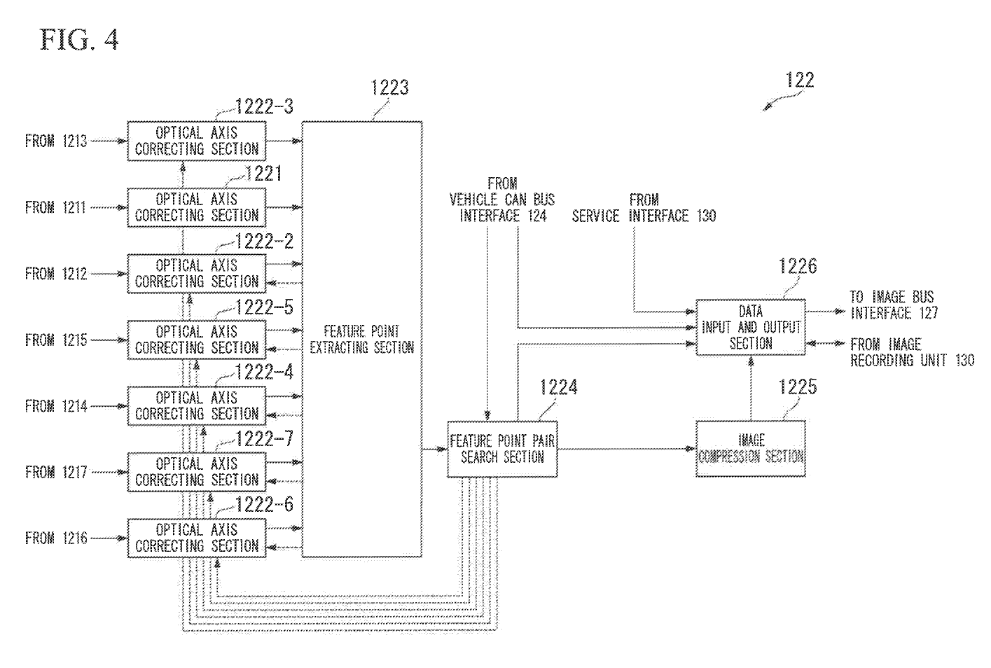

FIG. 4 is a schematic diagram showing the configuration of the image processing unit 122 related to the present embodiment.

The image processing unit 122 is configured to include an optical axis correcting section 1221, optical axis correcting sections 1222-2 to 1222-7, a feature point extracting section 1223, a feature point pair search section (image correction amount calculating section) 1224, an image compression section 1225, and a data input and output section.

Hereinafter, the front monitoring camera 211 will be described as a master camera. The master camera is a camera which captures an image signal as a reference in order to calculate the amount of image correction (which will be described later) related to image signals captured by other cameras. Cameras other than the master camera are called slave cameras.

The optical axis correcting section 1221 corrects the amount of optical axis correction of the front monitoring camera 211 with respect to an image signal (hereinafter, referred to as a master image (first image)) input from the front monitoring camera 211, which is a master camera, through the corresponding front monitoring camera interface 1211. The optical axis correcting section 1221 calculates the amount of optical axis correction in advance with respect to the master image using a known method (for example, a missing point estimation method, an optical flow detection method, or a direct method).

The optical axis correcting section 1221 corrects the master image by coordinate transformation using the calculated amount of optical axis correction and as a result, generates an optical-axis-corrected master image.

In this manner, a difference in the field of view caused by the installation position of the front monitoring camera 211 or the direction of the optical axis, which changes according to a vehicle or time, is corrected.

In addition, the optical axis correcting section 1221 performs coordinate transformation of the optical-axis-corrected master image, which is expressed in the camera coordinate system, to the world coordinate system and outputs the coordinate-transformed image signal (projected master image to be described later) to the feature point extracting section 1223.

Here, the relationship between the camera coordinate system (O_{c}—X_{c}Y_{c}Z_{c}) and the image coordinate system (Oₚ—XₚYₚ) will be described. The camera coordinate system is a coordinate system with the optical axis of a camera as its reference. The image coordinate system is a coordinate system with a photographing element (image sensor) of a camera as its reference.

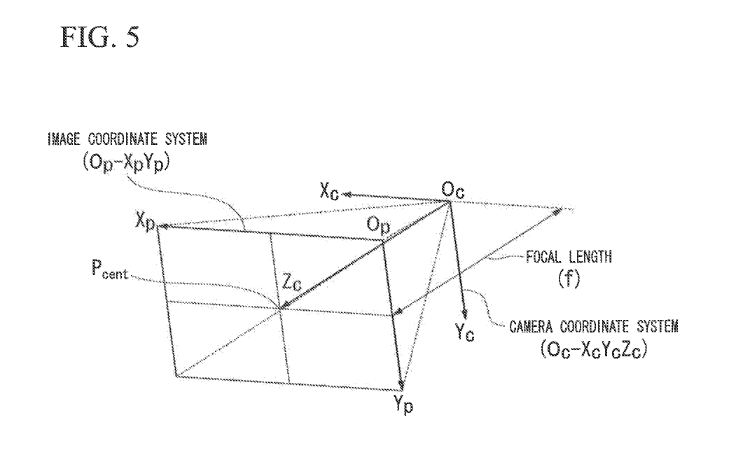

FIG. 5 shows examples of the camera coordinate system and the image coordinate system related to the present embodiment.

In FIG. 5, X_{c}, Y_{c}, and Z_{c} axes indicate coordinate axes of the camera coordinate system, and Xₚ and Yₚ axes indicate coordinate axes of the image coordinate system. O_{c} is the origin of the camera coordinate system, and Oₚ is the origin (last main point) of the image coordinate system.

In FIG. 5, an axis which connects the focal point O_{c} of a lens provided in a camera and the center P_{cent} of an image sensor is the optical axis, and this direction is the Z_{c} axis direction. The center P_{cent} of the image sensor is located at a position separated by the focal length f from the focal point O_{c} in a direction of the optical axis. The normal direction of the light receiving surface of the image sensor is parallel to the optical axis. A direction parallel to the horizontal direction of the image sensor is the X_{c} axis direction. A direction parallel to the vertical direction of the image sensor is the Y_{c} axis direction.

In the image coordinate system, the origin O_{c} is a pixel in the upper right corner of the image sensor, the Xₚ coordinate is a coordinate in the X_{c} axis direction from the origin O_{c}, and the Yₚ coordinate is a coordinate in the Y_{c} axis direction from the origin O_{c}.

Accordingly, the coordinates of a (Pxₛ, Pyₛ)-th pixel from the origin O_{c} which are expressed in the camera coordinate system are (f, Pxₛ, Pyₛ, 1)^{T}. Here, P indicates a distance between pixels on an image sensor. T indicates a transposition of a vector or a matrix.

Next, the relationship between the world coordinate system (O_{w}—X_{w}Y_{w}Z_{w}) and the camera coordinate system (Oₚ—XₚYₚ) will be described. The world coordinate system is a coordinate system including the entire space (in the present embodiment, fields of view of the cameras 211 to 217).

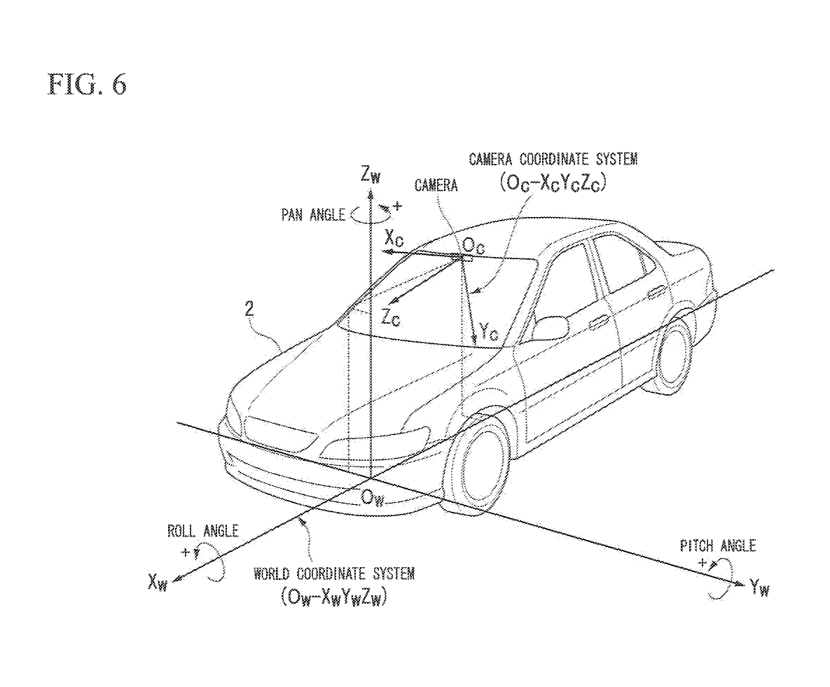

FIG. 6 shows examples of the world coordinate system and the camera coordinate system related to the present embodiment.

In FIG. 6, X_{w}, Y_{w}, and Z_{w} axes indicate coordinate axes of the world coordinate system, and X_{c}, Y_{c}, and Z_{c} axes indicate coordinate axes of the camera coordinate system. The X_{w} axis is a coordinate axis toward the front of the vehicle 2 along the horizontal plane. The Y_{w} axis is a coordinate axis toward the left along the horizontal plane for the front of the vehicle 2. The Z_{w} axis is a coordinate axis toward the vertical direction of the vehicle 2.

The roll angle θ is an angle rotating around the X_{w} axis. The pitch angle φ is an angle rotating around the Y_{w} axis direction. The pan angle ρ is an angle rotating around the Z_{w} axis.

In addition, the roll angle θ, pitch angle φ, and pan angle ρ of the optical axis of a camera in the world coordinate system are called the amount of roll angle deviation, the amount of pitch angle deviation, and the amount of pan angle deviation, respectively. The fixing position (X_{c}, Z_{c}) of the camera in the world coordinate system is called the amount of camera deviation. X_{c} and Y_{c} are called the amount of horizontal deviation and the amount of vertical deviation, respectively, and Z_{c} is called a height. That is, the amount of optical axis correction is a general term for the amount of horizontal deviation X_{c}, the amount of vertical deviation Y_{c}, the height Z_{c}, the amount of pan angle deviation ρ, the amount of pitch angle deviation 4), and the amount of roll angle deviation θ.

Therefore, the coordinates of each pixel on the image sensor expressed in the camera coordinate system can be converted to the world coordinate system using a matrix T_{cw} given by the following Equation.

$${T}_{cw} = ( \begin{matrix}1 & 0 & 0 & {X}_{c} \\ 0 & 1 & 0 & {Y}_{c} \\ 0 & 0 & 1 & {Z}_{c} \\ 0 & 0 & 0 & 1\end{matrix} ) ( \begin{matrix}1 & 0 & 0 & 0 \\ 0 & cos θ & - sin θ & 0 \\ 0 & sin θ & cos θ & 0 \\ 0 & 0 & 0 & 1\end{matrix} ) ( \begin{matrix}cos φ & 0 & sin φ & 0 \\ 0 & 1 & 0 & 0 \\ - sin φ & 0 & cos φ & 0 \\ 0 & 0 & 0 & 1\end{matrix} ) ( \begin{matrix}cos ρ & - sin ρ & 0 & 0 \\ sin ρ & cos ρ & 0 & 0 \\ 0 & 0 & 1 & 0 \\ 0 & 0 & 0 & 1\end{matrix} ) \qquad ( 1 )$$

In Equation (1), the first term is a matrix component for correcting the amount of camera deviation (X_{c}, Y_{c}, Z_{c}). This matrix component is a component for adding the amount of camera deviation to the coordinate expressed in the camera coordinate system. The second term is a matrix component for correcting the amount of roll angle deviation θ. This matrix component is a component for rotating the coordinates, which are expressed in the camera coordinate system, by the roll angle θ around the X_{w} axis direction. The third term is a matrix component for correcting the amount of pitch angle deviation φ. This matrix component is a component for rotating the coordinates, which are expressed in the camera coordinate system, around the Y_{w} axis direction by the pitch angle φ. The fourth term is a matrix component for correcting the amount of pan angle deviation. This matrix component is a component for rotating the coordinates, which are expressed in the camera coordinate system, around the Z_{w} axis direction by the pan angle ρ. In addition, a matrix T_{z0} for projecting the coordinates onto the plane where the coordinate (height) in the Z_{w} direction in the world coordinate system is zero (Z_{w}=0) is given by the following Equation.

$${T}_{z 0} = ( \begin{matrix}- {Z}_{c} & 0 & {X}_{c} & 0 \\ 0 & - {Z}_{c} & {Y}_{c} & 0 \\ 0 & 0 & 0 & 0 \\ 0 & 0 & 1 & - {Z}_{c}\end{matrix} ) \qquad ( 2 )$$

Returning to FIG. 4, the optical axis correcting section 1221 projects the coordinates (f, Pxₛ, Pyₛ, 1)^{T} expressed in the camera coordinate system onto the coordinates (x₁, y₁, 0, 1)^{T}, in which the coordinate in the Z_{w} direction in the world coordinate system is zero, using a matrix T_{z1} (T_{z1}=T_{z0}T_{cw}) based on the amount of optical axis correction.

In this manner, the optical axis correcting section 1221 corrects the amount of optical axis deviation of the front monitoring camera 211.

The image corrected in this manner is called a projected master image, and the optical axis correcting section 1221 outputs the projected master image to the feature point extracting section 1223.

When the amount of optical axis correction has not been set, the optical axis correcting section 1221 outputs the input master image to the feature point extracting section 1223 without performing the above-described coordinate transformation.

The optical axis correcting sections 1222-2 to 1222-7 correct the amounts of optical axis correction of the slave cameras (212 to 217 respectively) for image signals (hereinafter, referred to as slave images (second images)) input through the camera interfaces 1212 to 1217 corresponding to the slave cameras. In order to correct the amount of optical axis correction, the optical axis correcting sections 1222-2 to 1222-7 receive the amounts of optical axis correction for the slave cameras (212 to 217 respectively) from the feature point pair search section 1224 and perform coordinate transformation of the slave images for the slave cameras (212 to 217 respectively) using the input amounts of optical axis correction.

The optical axis correcting sections 1222-2 to 1222-7 output to the feature point extracting section 1223 the slave images (hereinafter, referred to as projected slave images) after correcting the amount of optical axis correction.

When the amount of optical axis correction has not been set or input, the optical axis correcting sections 1222-2 to 1222-7 output the slave images to the feature point extracting section 1223 without performing the above-described coordinate transformation.

The feature point extracting section 1223 extracts feature points from the projected master image input from the optical axis correcting section 1221 and the projected slave images input from the optical axis correcting sections 1222-2 to 1222-7. The feature point is a region where a change in the brightness value that makes up an image signal is more noticeable than the surroundings and is a region or a singular point with a very small area. For example, the feature point is an apex or a point of intersection of lane markings (white lines) drawn on the road. The feature point extracting section 1223 may extract feature points of the road markings drawn on the road without being limited to the lane markings.

The feature point extracting section 1223 divides the projected master image or the projected slave image (for example, 2048 pixels horizontally by 6144 pixels vertically) into small regions (cells, for example, 4 pixels horizontally by 4 pixels vertically) and extracts feature points using the feature amounts calculated for each block including a plurality of cells, for example, SIFT (Scale Invariant Feature Transform) feature amounts.

Here, processing when the feature point extracting section 1223 extracts feature points will be described.

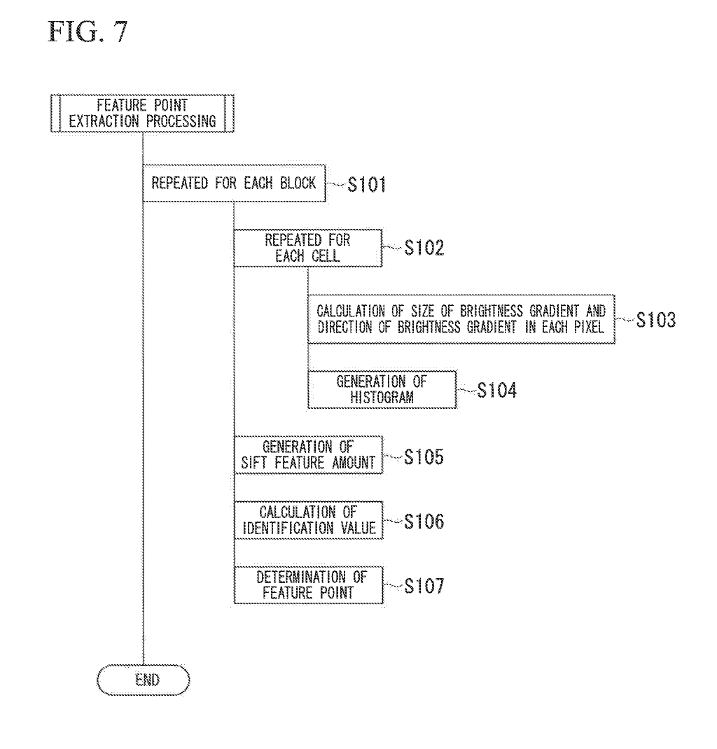

FIG. 7 is a flowchart showing the processing of extracting the feature points from an image signal in the present embodiment.

(Step S101) The feature point extracting section 1223 repeats processing in steps S102 to S107 for each block, and performs the processing until it is completed for all blocks in the image.

(Step S102) The feature point extracting section 1223 repeats processing in steps S103 to S104 for each cell, and performs the processing until it is completed for all cells in the image. Then, the process proceeds to step S105.

(Step S103) The feature point extracting section 1223 calculates the size m(i, j) of the brightness gradient and the direction L(i, j) of the brightness gradient in each pixel (i, j) based on the brightness value L(i, j) of each pixel (i, j) included in each cell using Equations (3) and (4).

$$\begin{matrix}m ( i , j ) = \sqrt{{{f}_{x} ( i , j )}^{2} + {{f}_{y} ( i , j )}^{2}} & ( 3 ) \\ Ψ ( i , j ) = {tan}^{- 1} \frac{{f}_{y} ( i , j )}{{f}_{x} ( i , j )} & ( 4 )\end{matrix}$$

In Equations (3) and (4), fₓ(i, j) is a brightness gradient in the horizontal (x) direction: L(i+1, j)−L(i−1, j), and f_{y}(i, j) is a brightness gradient in the vertical (y) direction: L(i, j+1)−L(i, j−1).

(Step S104) The feature point extracting section 1223 calculates the cumulative value (sum) in a cell with a size m(i, j) of the brightness gradient, as an element of a histogram v_{c}, for each section in a direction θ(i, j) of the brightness gradient (for example, at distances of 45°, a total of 8 sections). This histogram v_{c} is an 8-dimensional vector. For each histogram v_{c}, the feature point extracting section 1223 normalizes it by dividing it by the maximum value of the elements.

(Step S105) The feature point extracting section 1223 generates a SIFT feature amount v_{b} by compiling each element of the histogram v_{c}, which has been calculated and normalized for each cell, for each block. Here, the block refers to a region of an image formed by a plurality of cells (for example, 2 cells horizontally×2 cells vertically; 8 pixels horizontally×8 pixels vertically). In this example, the SIFT feature amount v_{b} is a 32-dimensional (8×2×2) vector.

(Step S106) The feature point extracting section 1223 reads a determination feature amount a_{b} from a storage region provided in itself, and calculates an identification value d_{b} based on the read determination feature amount a_{b} and the SIFT feature amount v_{b}. The determination feature amount a_{b} is a vector with the same number of dimensions as the SIFT feature amount v_{b}, and is a vector showing the characteristics of feature points that need to be detected. The feature point extracting section 1223 may store a plurality of determination feature amounts a_{b} corresponding to the shapes or positions of feature points that need to be detected. The identification value d_{b} is a variable indicating the similarity or correlation between the determination feature amount a_{b} and the SIFT feature amount v_{b}, for example, an inner product therebetween.

(Step S107) The feature point extracting section 1223 determines that a block with the larger identification value d_{b} than the threshold value set in advance is a block in which a feature point is present and sets the coordinates representing the block, for example, the center coordinates, as the coordinate information of the feature point.

Returning to FIG. 4, the feature point extracting section 1223 outputs to the feature point pair search section 1224 the projected master image, the projected slave image, and the coordinate information of the feature points extracted from these images.

The feature point pair search section 1224 receives from the feature point extracting section 1223 the projected master image, the projected slave image, and the coordinate information of the feature points extracted from these images.

The feature point pair search section 1224 searches for a pair of the feature point extracted from the projected master image and the feature point extracted from the corresponding projected slave image.

First, processing (search for a feature point pair between field-of-view-overlap cameras) of searching for pair of the feature point of a master image and the feature point of a slave image (field-of-view-overlap slave image) overlapping part of the field of view of the master image will be described.

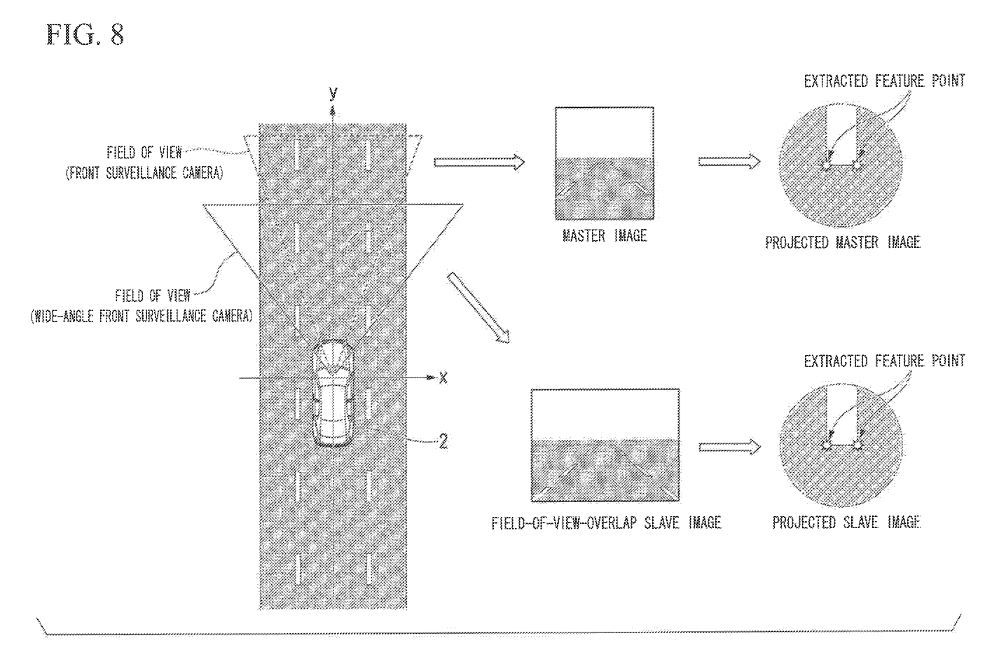

FIG. 8 is a conceptual diagram showing examples of a master image and a field-of-view-overlap slave image related to the present embodiment. In the present embodiment, the field-of-view-overlap slave image is an image captured by the wide-angle front monitoring camera 212.

A left portion of FIG. 8 shows a field of view (broken line) of the front monitoring camera 211 and a field of view (solid line) of the wide-angle front monitoring camera 212 provided in the vehicle 2 traveling on the road. The horizontal axis indicates an x coordinate in the world coordinate system, and the vertical axis indicates a y coordinate in the same coordinate system.

An upper middle portion of FIG. 8 shows an example of an image (master image) captured by the front monitoring camera 211.

A lower middle portion of FIG. 8 shows an example of an image (field-of-view-overlap slave image) captured by the wide-angle front monitoring camera 212.

An upper right portion of FIG. 8 is a portion in the circle drawn by a one-dotted chain line (one-dotted chain line circle) of the left portion in the same drawing, and shows a portion including feature points (asterisks) extracted from a projected master image based on the master image. A lower right portion of FIG. 8 is a portion in the one-dotted chain line circle of the left portion in the same drawing, and shows a portion including feature points (asterisks) extracted from a projected slave image based on the field-of-view-overlap slave image.

Here, the feature point pair search section 1224 calculates a difference between the coordinates of the feature point extracted from the projected slave image based on the field-of-view-overlap slave image and the coordinates of the feature point extracted from the projected master image. This projected slave image is formed by converting the coordinate value of each pixel of the field-of-view-overlap slave image into the world coordinate system using a matrix T_{z1} based on the amount of optical axis correction.

The feature point pair search section 1224 determines a feature point pair and the amount of optical axis correction, which minimize the square error based on the difference, as the amount of image correction.

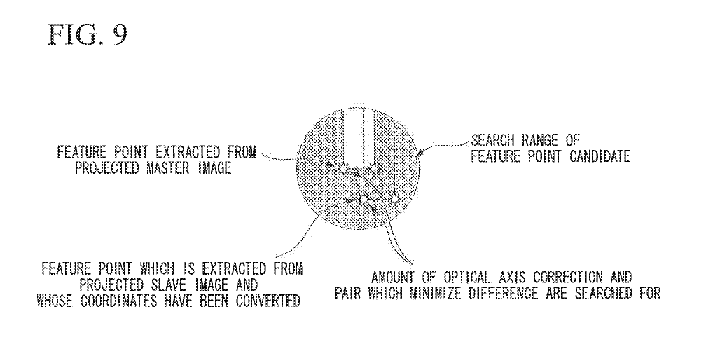

FIG. 9 is a conceptual diagram showing an example of the feature point related to the present embodiment. In FIG. 9, the solid line shows a projected slave image, and the broken line shows a projected slave image. In addition, the feature point of each image is shown by an asterisk in FIG. 9. Here, the feature point pair search section 1224 sets the amount of optical axis correction of the slave camera (in this example, a wide-angle front monitoring camera) based on the design value as an initial value and sets the feature point, which has been extracted from the field-of-view-overlap slave image with the coordinates in each range that is set in advance from the feature point extracted from the projected master image (refer to the one-dotted chain line circle in FIG. 9), as a candidate of the opposite feature point. When a plurality of such candidates are present, the feature point pair search section 1224 searches for the candidates of the feature point in order of a short distance from the feature point extracted from the projected master image. In addition, the feature point pair search section 1224 may search for the amount of optical axis correction within a range set in advance from the design value.

Next, processing (search for a feature point pair between field-of-view-separated cameras) of searching for a pair of the feature point of a projected master image and the feature point of a projected slave image based on a slave image (field-of-view-separated slave image) not overlapping the field of view of the master image will be described.

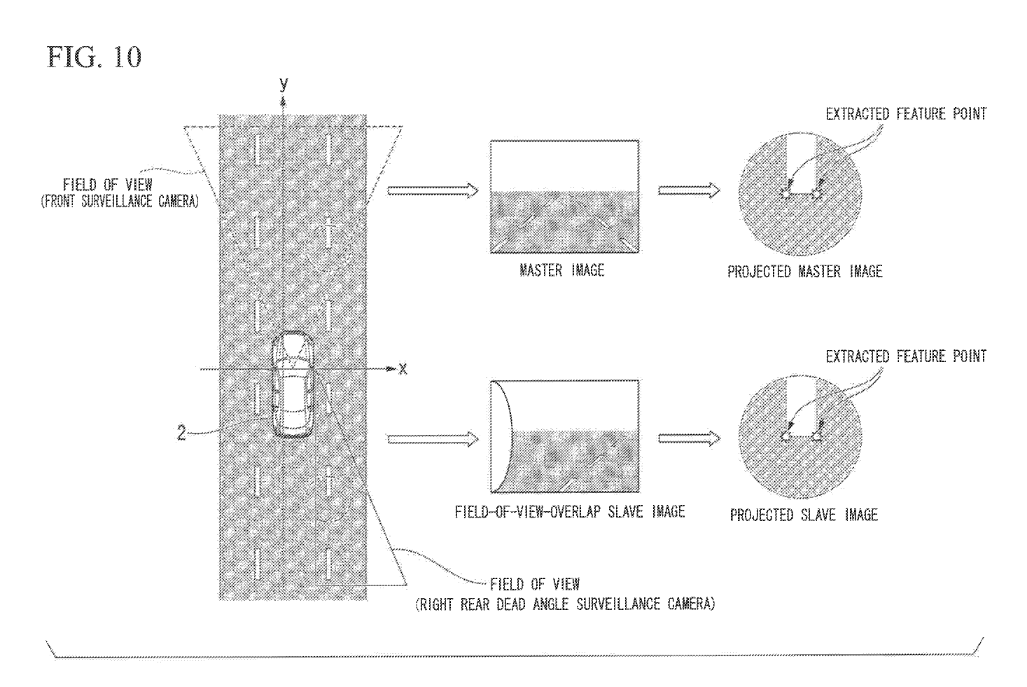

FIG. 10 is a conceptual diagram showing examples of a master image and a field-of-view-separated slave image related to the present embodiment. In the present embodiment, the field-of-view-separated slave image is an image captured by each of the left-and-right front dead angle monitoring camera 213, the left rear dead angle monitoring camera 214, the right rear dead angle monitoring camera 215, and the rear monitoring camera 217. However, FIG. 10 shows an image captured by the right rear dead angle monitoring camera 215 as an example of the field-of-view-separated slave image.

Moreover, in the present embodiment, the image captured by the vehicle inside monitoring camera 216 is not an object of the feature point pair search between the field-of-view-separated cameras.

A left portion of FIG. 10 shows a field of view (broken line) of the front monitoring camera 211 (master camera) and a field of view (solid line) of the right rear dead angle monitoring camera 215 (slave camera) provided in the vehicle 2 traveling on the road. The horizontal axis indicates an x coordinate in the world coordinate system, and the vertical axis indicates a y coordinate in the same coordinate system.

An upper middle portion of FIG. 10 shows an example of an image (master image) captured by the front monitoring camera 211. A lower middle portion of FIG. 10 shows an example of an image (field-of-view-separated slave image) captured by the vehicle inside monitoring camera 216.

An upper right portion of FIG. 10 shows a portion including feature points (asterisks), which are extracted from a projected master image based on the master image, in the one-dotted chain line circle of the upper left portion in the same drawing. A lower right portion of FIG. 10 shows a portion including feature points (asterisks), which are extracted from a projected slave image based on the field-of-view-overlap slave image, in the one-dotted chain line circle of the lower left portion in the same drawing.

That is, FIG. 10 shows that the field of view of the front monitoring camera 211 faces the front of the vehicle 2 and the field of view of the right rear dead angle monitoring camera 215 faces the right rear of the vehicle 2 and both of them do not overlap each other.

However, when the vehicle 2 moves, part of the master image may be included in the field-of-view-separated slave image due to being delayed. For example, the front monitoring camera 211 captures lane markings on the right side of the front of the vehicle 2 at a certain point of time, and the right rear dead angle monitoring camera 215 captures the lane markings after the vehicle 2 travels forward. In addition, the time until part of a master image is included in a field-of-view-separated slave image from the point of time of master image capturing depends on the vehicle information (speed information and yaw rate information) of the vehicle 2. For example, the time (appearance time) until part of a master image appears in a field-of-view-separated slave image from the point of time of master image capturing becomes short as the speed of the vehicle 2 increases.

Therefore, before the feature point pair search between the field-of-view-separated cameras is performed, the feature point pair search section 1224 predicts the coordinates of the feature point, which has been extracted from the master image based on the vehicle information input from the vehicle CAN bus interface 124.

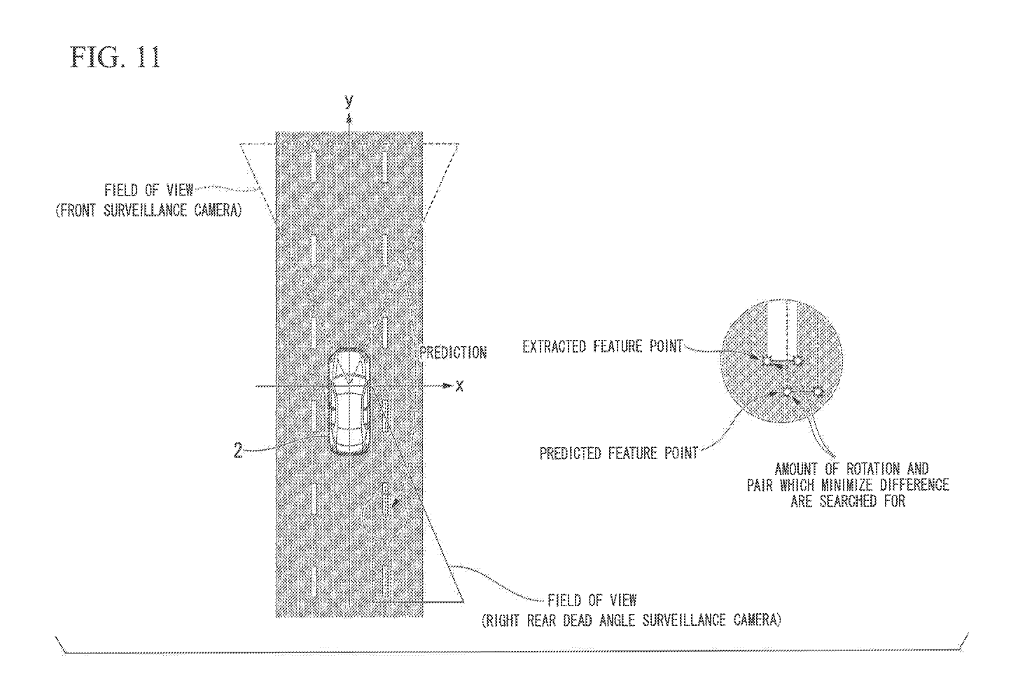

FIG. 11 is a conceptual diagram showing an example of an image predicted from the master image related to the present embodiment.

A left portion of FIG. 11 shows a field of view (broken line) of the front monitoring camera 211 (master camera) and a field of view (solid line) of the right rear dead angle monitoring camera 215 (slave camera) provided in the vehicle 2 traveling on the road. The horizontal axis indicates an x coordinate in the world coordinate system, and the vertical axis indicates a y coordinate. In addition, the arrow of the broken line toward the lower right from the upper right of the x coordinate shows that the position from the starting point, which is an end point of the arrow based on the vehicle information, is set as a predicted position.

A right portion of FIG. 11 is a projected master image and a projected slave image, and shows an enlarged portion of a region shown by the one-dotted chain line of a left portion in the same drawing. In the right portion in the same drawing, a white and vertically long rectangle indicates a line marker shown by the projected master image, and the feature points are shown on the base. In addition, a vertically long rectangle with a broken line indicates a line marker shown by the projected slave image after prediction, and the feature points are shown on the base.

Therefore, the feature point pair search section 1224 sets the feature point of the projected slave image after prediction, which is present within a range set in advance from the feature point extracted from the projected master image, as a candidate feature point. Then, the feature point pair search section 1224 sets the candidate feature point and the amount of image correction which minimize the difference between the coordinates of the extracted feature point and the coordinates of the candidate feature point.

Specifically, the feature point pair search section 1224 estimates the world coordinates (x′₁, y′₁, 1)^{T} at the point of time after time ΔT from the present based on the current world coordinates (x₁, y₁, 1)^{T}, the speed v indicated by the speed information, and the yaw rate η indicated by the yaw rate information.

$$( \begin{matrix}{x}_{1}^{′} \\ {y}_{1}^{′} \\ 1\end{matrix} ) = ( \begin{matrix}1 & 0 & {t}_{x} \\ 0 & 1 & {t}_{y} \\ 0 & 0 & 1\end{matrix} ) ( \begin{matrix}cos θ & - sin θ & 0 \\ sin θ & cos θ & 0 \\ 0 & 0 & 1\end{matrix} ) ( \begin{matrix}{x}_{1} \\ {y}_{1} \\ 1\end{matrix} ) \qquad ( 5 )$$

In Equation (5), (tₓ, t_{y}) is the amount of movement (vΔt·cos(Δt·θ′/2), vΔt·sin(Δt·θ′/2) based on the speed v and the yaw rate η. θ is a rotation angle Δt·η based on the yaw rate η.

The feature point pair search section 1224 searches for a pair of feature points between the coordinates of the corrected feature point and the coordinates of the feature point extracted from the projected slave image, and determines the amount of image correction of the field-of-view-separated slave image. In this case, the feature point pair search section 1224 performs the same processing as the above-described feature point pair search between field-of-view-overlap cameras.

That is, the world coordinates (x′₁, y′₁, 1)^{T} at the point of time after time ΔT is an initial value of the amount of camera deviation when searching for a pair of feature points. Here, the feature point pair search section 1224 may set the time ΔT so as to be inversely proportional to the speed v based on the design value of each camera, so that the coordinates of the corrected feature point and the coordinates of the feature point extracted from the projected slave image approximate to each other. In this manner, by limiting the number of combinations of feature points for searching for a pair of feature points or the range of the amount of image correction, the amount of operations can be reduced.

Also for field-of-view-separated slave images based on image signals captured by other slave cameras, the feature point pair search section 1224 performs the same processing.

Returning to FIG. 4, the feature point pair search section 1224 outputs the amount of image correction, which has been determined for each slave camera, to the data input and output section 1226. The feature point pair search section 1224 outputs the image signal of each camera, that is, the projected master image and the projected slave image to the image compression section 1225.

In addition, the feature point pair search section 1224 outputs the amount of image correction, which has been determined for each slave camera, to each of the corresponding optical axis correcting sections 1222-2 to 1222-7.

The image compression section 1225 performs compression encoding of the image signal of each camera input from the feature point pair search section 1224 using a known image encoding technique (for example, Motion-JPEG) and as a result, generates a compressed image signal with a smaller amount of information.

The image compression section 1225 outputs the generated compressed image signal to the data input and output section 1226.

The compressed image signal from the image compression section 1225, the amount of image correction from the feature point pair search section 1224, the vehicle information from the vehicle CAN bus interface 124, and the event information from the service interface 129 are input to the data input and output section 1226.

The data input and output section 1226 outputs the input compressed image signal and the input amount of image correction to the image bus interface 127 in synchronization with each camera.

The data input and output section 1226 outputs to the image recording unit 130 the compressed image signal, the amount of image correction, the vehicle information, and the event information which have been input. When outputting the compressed image signal and the amount of image correction to the image recording unit 130, the data input and output section 1226 synchronizes these with each camera.

The data input and output section 1226 receives the compressed image signal, the amount of image correction, the vehicle information, and the event information from the image recording unit 130.

Next, image processing performed by the image processing system 1 related to the present embodiment performs will be described.

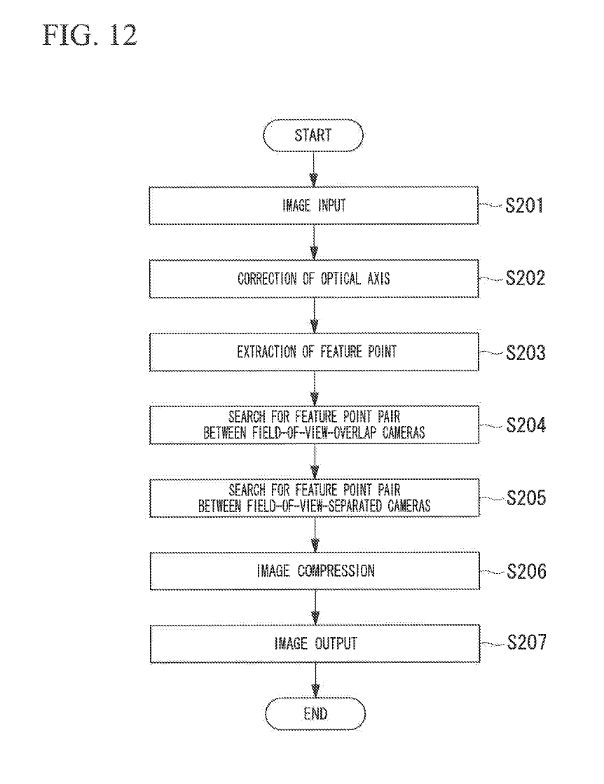

FIG. 12 is a flowchart showing the image processing related to the present embodiment.

(Step S201) A master image showing an image captured by the front monitoring camera 211 (master camera) is input to the front monitoring camera interface 1211, and the front monitoring camera interface 1211 outputs the input master image to the optical axis correcting section 1221. Slave images showing images captured by the cameras 212 to 217 (slave cameras) are input to the camera interfaces 1212 to 1217, and the camera interfaces 1212 to 1217 output the input slave images to the optical axis correcting sections 1222-2 to 1222-7. Then, the process proceeds to step S202.

(Step S202) The optical axis correcting section 1221 performs optical axis correction for the coordinates of each pixel, which forms the master image input from the front monitoring camera interface 1211, using the matrix T_{z1} based on the amount of optical axis correction set in advance. The optical axis correcting section 1221 performs coordinate transformation of the coordinates of each pixel in the image signal, which has been input in the above-described optical axis correction, from the camera coordinate system to the world coordinate system. The optical axis correcting section 1221 outputs the optical-axis-corrected image signal (projected master image) to the feature point extracting section 1223.

The optical axis correcting sections 1222-2 to 1222-7 perform optical axis correction for the coordinates of each pixel, which forms the slave images input from the camera interfaces 1212 to 1217, using the matrix T_{z1} based on the amount of optical axis correction input from the feature point pair search section 1224. The optical axis correcting sections 1222-2 to 1222-7 perform coordinate transformation of the coordinates of each pixel in the image signal, which has been input in the above-described optical axis correction, from the camera coordinate system to the world coordinate system. The optical axis correcting sections 1222-2 to 1222-7 output the optical-axis-corrected master image signal (projected master image) a to the feature point extracting section 1223. Then, the process proceeds to step S202.

(Step S203) The feature point extracting section 1223 extracts feature points from the projected master image input from the optical axis correcting section 1221 and the projected slave images input from the optical axis correcting sections 1222-2 to 1222-7. The feature point extracting section 1223 performs processing shown in FIG. 5, for example, in order to extract the feature points.

The feature point extracting section 1223 outputs to the feature point pair search section 1224 the projected master image, the projected slave images, and the coordinate information of the feature points extracted from these images. Then, the process proceeds to step S204.

(Step S204) The feature point pair search section 1224 performs processing (feature point pair search between field-of-view-overlap cameras) of searching for a pair of the feature point of the projected master image input from the feature point extracting section 1223 and the feature point of the projected slave image based on the field-of-view-overlap slave image. The feature point pair search between field-of-view-overlap cameras will be described later. Then, the process proceeds to step S205.

(Step S205) The feature point pair search section 1224 performs processing (feature point pair search between field-of-view-separated cameras) of searching for a pair of the feature point of the projected master image input from the feature point extracting section 1223 and the feature point of the projected slave image based on the field-of-view-separated slave image. The feature point pair search between field-of-view-separated cameras will be described later. Then, the process proceeds to step S206.

(Step S206) The feature point pair search section 1224 outputs to the data input and output section 1226 the amount of image correction of each camera determined by performing feature point pair search between field-of-view-overlap cameras and feature point pair search between field-of-view-separated cameras. In addition, the feature point pair search section 1224 outputs the amount of image correction to the corresponding optical axis correcting sections 1222-2 to 1222-7. The feature point pair search section 1224 outputs the image signal of each camera, that is, a corrected master image and a corrected slave image to the image compression section 1225.

The image compression section 1225 performs compression encoding of the image signal, which has been input from the feature point pair search section 1224, to generate a compressed image signal. The image compression section 1225 outputs the generated compressed image signal to the data input and output section 1226. Then, the process proceeds to step S207.

(Step S207) The compressed image signal from the image compression section 1225, the amount of image correction from the feature point pair search section 1224, the vehicle information from the vehicle CAN bus interface 124, and the event information from the service interface 129 are input to the data input and output section 1226.

The data input and output section 1226 outputs the input compressed image signal and the amount of image correction to the image bus interface 127 in synchronization with each camera.

The data input and output section 1226 outputs the compressed image signal, the amount of image correction, the vehicle information, and the event information, which have been input, to the image recording unit 130 in synchronization with each camera. Then, a series of processing is ended.

Next, the feature point pair search between field-of-view-overlap cameras (step S204) related to the present embodiment will be described.

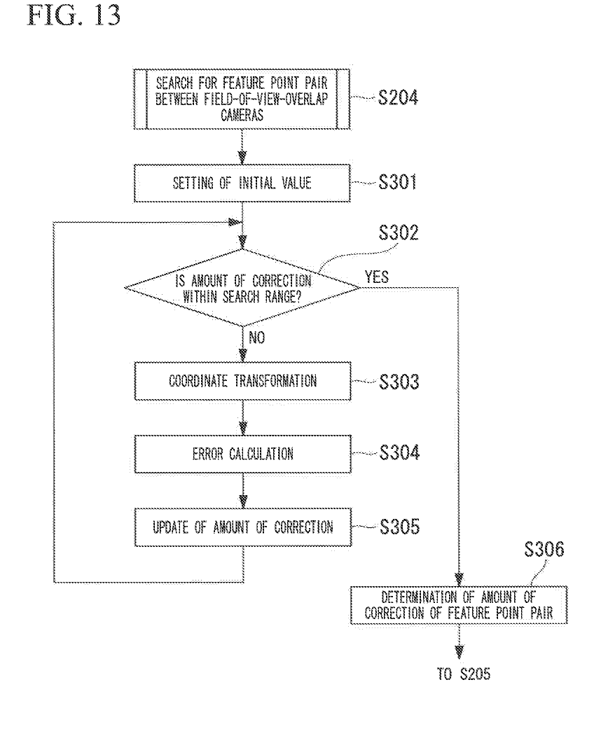

FIG. 13 is a flowchart showing the feature point pair search between field-of-view-overlap cameras related to the present embodiment.

(Step S301) The feature point pair search section 1224 sets the amount of optical axis correction of the slave camera based on the design value as an initial value. In addition, the feature point pair search section 1224 sets a candidate feature point, which is in a range set in advance and is a candidate of the opposite feature point, from the feature points extracted from the master image and sets a range for searching for the amount of optical axis correction. Then, the process proceeds to step S302.

(Step S302) The feature point pair search section 1224 determines whether or not the amount of optical axis correction is within a range of the set value. When the feature point pair search section 1224 determines that the amount of optical axis correction is not within a range of the set value (No in step S302), the process proceeds to step S303. When the feature point pair search section 1224 determines that the amount of optical axis correction is within a range of the set value (Yes in step S302), the process proceeds to step S306.

(Step S303) The feature point pair search section 1224 converts the coordinates of the feature point, which has been extracted from the projected slave image based on the field-of-view-overlap slave image, into the world coordinate system using the matrix T₁₁ based on the amount of optical axis correction. Then, the process proceeds to step S304.

(Step S304) The feature point pair search section 1224 calculates a difference between the coordinates converted in step S303 and the coordinates of the feature point extracted from the projected master image. Then, the process proceeds to step S305.

(Step S305) The feature point pair search section 1224 updates the amount of optical axis correction. Then, the process proceeds to step S302.

(Step S306) The feature point pair search section 1224 determines a feature point pair and the amount of optical axis correction, which minimize the square error based on the difference calculated in step S304, as the amount of image correction.

Then, the process proceeds to step S205.

Next, the feature point pair search between field-of-view-separated cameras (step S205) related to the present embodiment will be described.

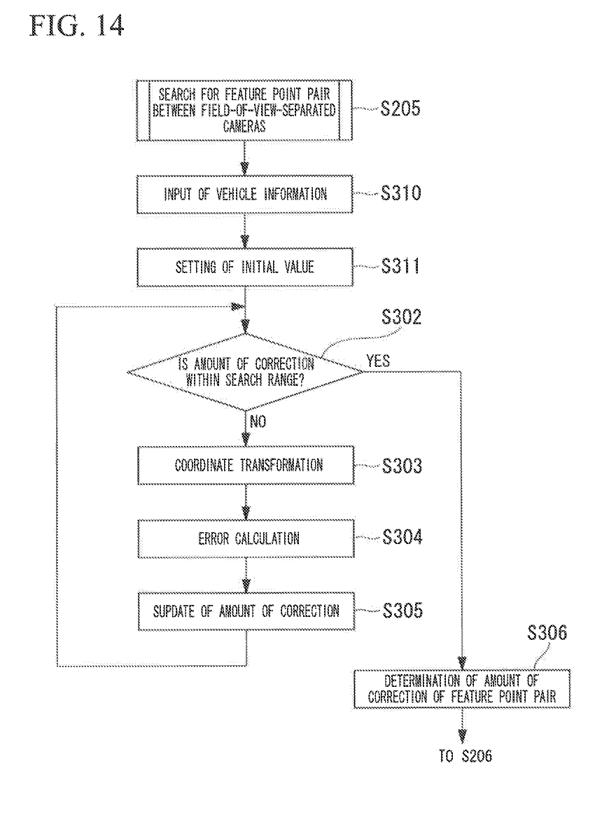

FIG. 14 is a flowchart showing the feature point pair search between field-of-view-separated cameras related to the present embodiment. The feature point pair search between field-of-view-separated cameras has steps S310 and S311 instead of step S301 of the feature point pair search between field-of-view-overlap cameras shown in FIG. 13, and the process proceeds to step S206 after the end.

(Step S310) The feature point pair search section 1224 receives the speed information and the yaw rate information as the vehicle information from the vehicle CAN bus interface 124. Then, the process proceeds to step S302.

(Step S311) The feature point pair search section 1224 estimates the world coordinates of the feature point, which has been extracted from the master image, after appearance time ΔT based on the current world coordinates and the input speed information and yaw rate information using Equation (5), for example. The feature point pair search section 1224 sets a candidate feature point, which is in a range set in advance and is a candidate of the opposite feature point, from the feature points based on the estimated feature point.

In addition, the feature point pair search section 1224 sets a range for searching for the amount of optical axis correction. In addition, the feature point pair search section 1224 sets the amount of optical axis correction of the slave camera based on the design value as an initial value of the amount of optical axis correction, and sets a range for searching for the amount of optical axis correction. Then, the process proceeds to step S302. The processing performed on the field-of-view-separated slave image in steps S302 to S306 is the same as the processing performed on the field-of-view-overlap slave image in steps S302 to S306 in FIG. 11. Then, the process proceeds to step S206.

In the present embodiment, other cameras may be used as the master camera instead of the front monitoring camera 211.

In the present embodiment, the optical axis correcting section 1221 may output the optical axis correction master image generated as described above to the image compression section 1225, and the optical axis correcting sections 1222-2 to 1222-7 may output the input slave images to the image compression section 1225. In this case, the image compression section 1225 may generate a compressed image signal by compressing the input optical-axis-corrected master image and the input slave images as an input image signal of each camera.

In the present embodiment, the feature point extracting section 1223 may extract a feature point based on the edge extracted by edge extraction instead of the method using the SIFT feature amount.

In the present embodiment, the image processing apparatus 10 may further include a communication interface which enables communication with the outside of the apparatus or the vehicle 2. When a request signal from the outside is input, the communication interface may read an image signal and corresponding event information and vehicle information from the image recording unit 130 and output them to the outside. In this manner, the image processing apparatus 10 related to the present embodiment provides a monitor image and additional event information and vehicle information for the service factory or the vehicle owner.

Thus, according to the present embodiment, estimation is performed based on the vehicle information, and the amount of image correction is calculated based on the positional relationship between an image acquired by one image acquisition unit and images acquired by other image acquisition units. Since the image correction value is calculated based on the images acquired by the plurality of image acquisition units, the vehicle information, and the positional relationship between images, an image is corrected based on the calculated image correction value and a plurality of images are managed collectively. Therefore, it becomes easy to construct a system that uses these images.

In addition, according to the present embodiment, the image correction value is calculated based on the positional relationship between the feature point of one image and the feature points of other images. Since the positional relationship of each image is represented by these feature points, the image correction value can be easily calculated.

In addition, according to the present embodiment, feature points of other images are searched for within a range set in advance from the feature points of one image. Therefore, it is possible to reduce the amount of operations for the search.

A part of the image processing apparatus 10 according to the above-mentioned embodiments, such as the optical axis correcting section 1221, the optical axis correcting sections 1222-2 to 1222-7, the feature point extracting section 1223, the feature point pair search section 1224, the image compression section 1225, and the data input and output section 1226 may be embodied by a computer. In this case, the part may be embodied by recording a program for performing the control functions in a computer-readable recording medium and causing a computer system to read and execute the program recorded in the recording medium. Here, the “computer system” is built in the image processing apparatus 10 and includes an OS or hardware such as peripherals. Examples of the “computer-readable recording medium” include memory devices of portable mediums such as a flexible disk, a magneto-optical disc, a ROM, and a CD-ROM, a hard disk built in the computer system, and the like. The “computer-readable recording medium” may include a recording medium dynamically storing a program for a short time like a transmission medium when the program is transmitted via a network such as the Internet or a communication line such as a phone line and a recording medium storing a program for a predetermined time like a volatile memory in a computer system serving as a server or a client in that case. The program may embody a part of the above-mentioned functions. The program may embody the above-mentioned functions in cooperation with a program previously recorded in the computer system.

In addition, part or all of the image processing apparatus according to the above-mentioned embodiments may be embodied as an integrated circuit such as an LSI (Large Scale Integration). The functional blocks of the image apparatus may be individually formed into processors and a part or all thereof may be integrated as a single processor. The integration technique is not limited to the LSI, but they may be embodied as a dedicated circuit or a general-purpose processor. When an integration technique taking the place of the LSI appears with the development of semiconductor techniques, an integrated circuit based on the integration technique may be employed.

It is also possible to economically configure the image processing system 1 according to the present embodiment by limiting the number of the cameras included in the image processing system 1 to a small number (for example, two front monitoring cameras may be used) under the above configuration.

While an embodiment of the invention has been described in detail with reference to the drawings, practical configurations are not limited to the above-described embodiment, and design modifications can be made without departing from the scope of this invention.

What is claimed is:

1. An image processing apparatus comprising:
image acquisition units which are mounted in a vehicle, and each of which is configured to acquire an image;
a vehicle information acquisition unit configured to acquire vehicle information indicating a movement state of the vehicle; and
an image correction amount calculation unit configured to calculate an amount of image correction based on positional relationship between a first image acquired by one of the image acquisition units and a second image acquired by the other image acquisition units,
wherein the positional relationship is estimated based on the vehicle information.

2. The image processing apparatus according to claim 1, further comprising:
a feature point extraction unit configured to extract feature points from the images,
wherein the image correction amount calculation unit is configured to calculate, as the positional relationship, positional relationship between feature points of the first image and feature points of the second image.

3. The image processing apparatus according to claim 2,
wherein the image correction amount calculation unit is configured to search for feature points of the second image within a range set in advance based on feature points of the first image.

4. An image processing method comprising:
a step of acquiring images by image acquisition units mounted in a vehicle;
a step of acquiring vehicle information indicating a movement state of the vehicle;
a step of estimating positional relationship between a first image acquired by one of the image acquisition units and a second image acquired by the other image acquisition units based on the vehicle information; and
a step of calculating an amount of image correction based on the positional relationship.

5. An image processing program causing a computer of an image processing apparatus including: image acquisition units which are mounted in a vehicle, and each of which is configured to acquire an image; and a vehicle information acquisition unit configured to acquire vehicle information indicating a movement state of the vehicle, to execute:
a step of acquiring images by the image acquisition units;
a step of acquiring vehicle information indicating a movement state of the vehicle;
a step of estimating positional relationship between a first image acquired by one of the image acquisition units and a second image acquired by the other image acquisition units based on the vehicle information; and
a step of calculating an amount of image correction based on the positional relationship.
